(19) United States
(12) Patent Application Publication
(10) Pub. No.: US 2013/0071143 A1
(43) Pub. Date: Mar. 21, 2013

(54) ANTIBACTERIAL AND ANTIFUNGAL PROTECTION FOR TONER IMAGE

(71) Applicants: Thomas Nelson Blanton, Rochester, NY (US); John Joseph Scheible, Fairport, NY (US); Greg Munro, Abderdeen (GB); Tomas Gerard Patrick McHugh, Webster, NY (US); Peter David Rollinson, Rochester, NY (US); Robert J. Vandenbosch, Rochester, NY (US); Jeffrey R. Murray, Palmyra, NY (US)

(72) Inventors: Thomas Nelson Blanton, Rochester, NY (US); John Joseph Scheible, Fairport, NY (US); Greg Munro, Abderdeen (GB); Tomas Gerard Patrick McHugh, Webster, NY (US); Peter David Rollinson, Rochester, NY (US); Robert J. Vandenbosch, Rochester, NY (US); Jeffrey R. Murray, Palmyra, NY (US)

(21) Appl. No.: 13/235,789

(22) Filed: Sep. 19, 2011

(51) Int. Cl. G03G 15/01; G03G 15/20

(52) U.S. Cl. 399/223; 399/341

(57) ABSTRACT

A method of forming a clear toner overcoat or a colored toner image on a substrate is disclosed. The overcoat or colored image provides antibacterial and antifungal protection. The method includes providing a source of toner having a mixture of polymer agent and a silver salt biocide including a silver sulfate biocide having a concentration range of 0.0005 to 10 weight %, applying the clear toner or colored toner in an image wise fashion to a substrate, and fixing the clear or colored toner to the substrate whereby an effective coating or image is formed that provides antibacterial and antifungal protection.

### FIELD OF THE INVENTION

The present invention relates to forming toner coatings or toner images on a substrate which have antimicrobial efficacy.

### BACKGROUND OF THE INVENTION

Electrophotographic printers produce images by transferring polymeric toner particles from a photoreceptor to a receiver and fixing the toner particles to the receiver with heat and pressure.

Conventional toner particles or powder or dry ink used in electrophotographic printing machines is a blend of materials, including plastic resins, coloring pigments and other ingredients. Most toners are produced in bulk using a melt mixing or hot compounding process. Plastic resins, carbon black, magnetic iron oxides, waxes or oils and charge control agents are blended together while in a molten state to thereby form a hot melt. This mixture is then cooled, typically by forming it into slabs on a cooling belt or by pelletizing the mixture and cooling the pellets. The toner pellets are then ground or pulverized into a toner powder by, for example, jet mills or air-swept hammer mills. This process produces a powder having a wide range of particle sizes. The toner powder is then sifted or classified to remove over-size and under-size toner particles. Most toner powders produced today for use in electrophotographic printing processes have a volume-median particle size of from approximately 4 to approximately 14 microns.

Another method of making toner particles is evaporative limited coalescence (ELC), described in U.S. Pat. No. 7,754,409. This method includes the following steps: mixing a polymer material, a solvent and optionally a colorant, wax, charge control agent, and other additives to form an organic phase; dispersing the organic phase in an aqueous phase comprising a particulate stabilizer and homogenizing the mixture; evaporating the solvent and washing and drying the resultant product.

The ELC process can also be modified to make porous toner particles as described in U.S. Pat. No. 7,888,410 and U.S. Pat. No. 7,867,679. Porous toner particles in the electrophotographic process can potentially reduce the toner mass in the image area. Simplistically, a toner particle with 50% porosity should require only half as much mass to accomplish the same imaging results. Toner particles having an elevated porosity will lower the cost per page and decrease the stack height of the print as well. The application of porous toners provides a practical approach to reduce the cost of the print and improve the print quality.

The toner particles can then be surface treated with various additives, such as charge control agents, in order to adjust various characteristics of the toner particles. As described in U.S. Pat. No. 6,200,722 surface treatment of toners with fine metal oxide powders, such as fumed silica or titania, results in toner and developer formulations that have improved powder flow properties and reproduce text and half tone dots more uniformly without character voids.

Widespread attention has been focused in recent years on the consequences of bacterial and fungal contamination contracted by contact with common surfaces and objects. Some noteworthy examples include the sometimes fatal outcome from food poisoning due to the presence of particular strains of Escherichia coli in undercooked beef; Salmonella contamination in undercooked and unwashed poultry food products; as well as illnesses and skin irritations due to Staphylococcus aureus and other micro-organisms. Anthrax is an acute infectious disease caused by the spore-forming bacterium bacillus anthracis. Allergic reactions to molds and yeasts are a major concern to many consumers and insurance companies alike. In addition, significant fear has arisen in regard to the development of antibiotic-resistant strains of bacteria, such as methicillin-resistant Staphylococcus aureus (MRSA) and vancomycin-resistant Enterococcus (VRE). The Centers for Disease Control and Prevention estimates that 10% of patients contract additional diseases during their hospital stay and that the total deaths resulting from these nosocomially-contracted illnesses exceeds those suffered from vehicular traffic accidents and homicides. In response to these concerns, manufacturers have begun incorporating antimicrobial agents into materials used to produce objects for commercial, institutional and residential use.

Noble metal ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal ions, metal salts, or compounds containing metal ions having antimicrobial properties can be applied to surfaces to impart an antimicrobial property to the surface. If, or when, the surface is inoculated with harmful microbes, the antimicrobial metal ions or metal complexes, if present in effective concentrations, will slow or even prevent altogether the growth of those microbes. Recently, silver sulfate, Ag₂SO₄, described in U.S. Pat. No. 7,579,396, U.S. Patent Application Publication 20080242794, U.S. Patent Application Publication 20090291147, U.S. Patent Application Publication 20100093851, and U.S. Patent Application Publication 20100160486 has been shown to have efficacy in providing antimicrobial protection in polymer composites. The United States Environmental Protection Agency (EPA) evaluated silver sulfate as a biocide and registered its use as part of EPA Reg. No, 59441-8 EPA EST. NO. 59441-NY-001. In granting that registration, the EPA determined that silver sulfate was safe and effective in providing antibacterial and antifungal protection.

Antimicrobial activity is not limited to noble metals but is also observed in organic materials such as triclosan, and some polymeric materials.

It is important that the antimicrobial active element, molecule, or compound be present on the surface of the article at a concentration sufficient to inhibit microbial growth. This concentration, for a particular antimicrobial agent and bacterium, is often referred to as the minimum inhibitory concentration (MIC). It is also important that the antimicrobial agent be present on the surface of the article at a concentration significantly below that which can be harmful to the user of the article. This prevents harmful side effects of the article and decreases the risk to the user, while providing the benefit of reducing microbial contamination. There is a problem in that the rate of release of antimicrobial ions from antimicrobial films can be too facile, such that the antimicrobial article can quickly be depleted of antimicrobial active materials and become inert or non-functional. Depletion results from rapid diffusion of the active materials into the biological environment with which they are in contact, for example, water soluble biocides exposed to aqueous or humid environments. It is desirable that the rate of release of the antimicrobial ions or molecules be controlled such that the concentration of antimicrobials remains above the MIC. The concentration should remain there over the duration of use of the antimicrobial article. The desired rate of exchange of the antimicrobial can depend upon a number of factors including the identity of the antimicrobial metal ion, the specific microbe to be targeted, and the intended use and duration of use of the antimicrobial article.

The use of a water soluble organic material biocide to prevent the formation of mold or bacterial growth during storage of toner compositions is disclosed in U.S. Patent Application Publication 20110027712. U.S. Patent Application Publication 20110086301 also discloses the use of water soluble organic material biocides to toner composition to reduce or eliminate degradation in molecular weight of polyester resin. However, being water soluble, these toner compositions will quickly fall below the MIC when exposed to aqueous or humid environments.

The use of toner with inorganic oxides with proposed antimicrobial properties for use in high temperature applications is disclosed in WO2005015319. The toner particle contains AgO, CuO, ZnO, or SnO in polymer as the biocide and also contains glass or ceramic particles. The resulting coated layer must be baked 300 to 500° C. to evaporate or burn away any organic residue. Such a composition will not work in a conventional electrophotographic printing device. A paper or plastic substrate with an image of this composition would not survive the 300 to 500° C. thermal processing step.

### SUMMARY OF THE INVENTION

Certain types of antimicrobial biocides can be effectively incorporated in toners without having any consequential degradation of the toner images for a viewer. Also, certain types of silver salts can be advantageously used in toner as a biocide without degrading the toner image. Silver sulfate can be particularly suitable for use in toner particles in that it can be deposited onto a substrate or support that can survive the deposition process, and be able to be delivered to the substrate or support using an electrophotographic printing device without charging or other processing issues.

The present invention recognizes that toner coatings and toner images on substrates including menus, letters, pictures, documents and the like can be a source of microorganisms such as bacteria or fungi via handling, nasal discharges, and contact with infected persons. Such microbe colonies can be destroyed or their growth inhibited if the print substrate is treated with an effective antimicrobial agent (toner).

In accordance with the present invention there is provided a method of forming a clear toner overcoat or a colored toner image providing antibacterial and antifungal protection on a substrate, comprising:

providing a source of toner having a mixture of polymer agent and a silver salt biocide including a silver sulfate biocide having a concentration of 0.0005 weight % to 10 weight %;

applying the clear toner or the colored toner in an image wise fashion to a substrate; and

fixing the clear or colored toner to the substrate whereby an effective coating or image is formed that destroys, inhibits or prevents the growth of microbes by providing antibacterial and antifungal protection.

The present invention recognizes and demonstrates that silver sulfate can work in this application and is very effective in providing antibacterial and antifungal protection, is compatible with polymers used to make electrophotographic toners, and does not degrade the image when used in the range of 0.0005 weight % to 10 weight %. It has also been recognized that producing coatings and images provided by the present invention does not interfere with the electrophotographic printing process. It is further recognized that coating or image articles provided by the present invention are safe for contact by the users of the article.

### DETAILED DESCRIPTION OF THE INVENTION

Toner particles suitable for this invention can be made by any of the methods described above, namely (1) Conventional melt processed and mechanically ground, (2) Evaporative Limited Coalescence, or (3) ELC modified to make porous particles. In each case, the unique method to incorporate the silver sulfate into the polymer matrix needs to meet at least two criteria: (1) It must not interfere with the other ingredient's function in providing suitable images via electrophotographic printing and (2) It must provide a suitable amount of silver (greater than MIC) to be effective in providing antimicrobial protection to the print.

In the present invention, toner can be a particle or powder, and can be a mixture of polymer agent and silver salt. The toner can be a dry toner or a liquid toner. Silver sulfate, Ag₂SO₄, is a preferred silver salt. Silver sulfate is defined as an antimicrobial agent, an antibacterial agent, an antifungal agent, or biocide. Silver salts that are defined as an antimicrobial agent, an antibacterial agent, an antifungal agent, or biocide further include silver nitrate, silver chloride, silver bromide, silver iodide, silver iodate, silver bromate, silver tungstate, or silver phosphate. The toner can contain a colorant, wax, charge control agent, and other additives such as a magnetic carrier for example iron oxide or any combination thereof. The toner can have a surface treatment agent on the surface of the particle. Additives are defined as silver sulfate, charge transfer agent, colorant, wax, surface treatment agent or any combination thereof. The concentration of additive is defined as the ratio of total mass of additive to total mass of toner multiplied by 100 to give a weight % of additive. The toner particle size in microns by volume percent as measured using a Coulter Counter Multisizer II has a preferred range of 0.5-100 microns by volume, a more preferred range of 1-75 microns by volume, and a most preferred range of 2-50 microns by volume.

Silver sulfate used in this invention can be prepared by a number of methods as disclosed in U.S. Pat. No. 7,261,867, U.S. Pat. No. 7,655,212, U.S. Pat. No. 7,931,880, and U.S. Patent Application Publication 20090258218. Included in these methods is silver sulfate prepared in aqueous solution by adding together a soluble silver salt and a soluble inorganic sulfate together under turbulent mixing conditions in a precipitation reactor. An additional method to prepare silver sulfate includes precipitation in nonaqueous solutions. Still further methods to prepare silver sulfate include solid state reaction, thermal processing, sputtering, and electrochemical processing. Additives can be included during the preparation process including size control agents, color control agents, antioxidants, and the like. Silver sulfate in this invention can be used as made or milled or ground to a smaller particle size. The final particle size of the silver sulfate used in this invention must be smaller than the particle size of the toner particle. Determination of particle size is carried out using grain size measurements provided for by instance an LA-920 analyzer from Horiba Instruments, Inc. The preferred silver sulfate particle size is in a range of greater than zero but less than 20 microns, the more preferred silver sulfate particle size is in a range of greater than zero but less than 10 microns, and the most preferred silver sulfate particle size is in a range of greater than zero but less than 5 microns.

In the present invention, toner particles include a plastic resin or polymer agent. These polymer agents include those derived from vinyl monomers, such as styrene monomers, or condensation monomers such as esters and mixtures thereof. These polymer agents include homopolymers and copolymers such as polyesters, styrenes, e.g. styrene or chlorostyrene; monoolefins, e.g. ethylene, propylene, butylene or isoprene; vinyl esters, e.g. vinyl acetate, vinyl propionate, vinyl benzoate or vinyl butyrate; α-methylene aliphatic monocarboxylic acid esters, e.g. methyl acrylate, ethyl acrylate, butyl acrylate, dodecyl acrylate, octyl acrylate, phenyl acrylate, methyl methacrylate, ethyl methacrylate, butyl methacrylate or dodecyl methacrylate; vinyl ethers, e.g. vinyl methyl ether, vinyl ethyl ether and vinyl butyl ether; or vinyl ketones, e.g. vinyl methyl ketone, vinyl hexyl ketone and vinyl isopropenyl ketone. Particularly desirable binder polymers/resins include polystyrene resin, polyester resin, styrene/alkyl acrylate copolymers, styrene/alkyl methacrylate copolymers, styrene/acrylonitrile copolymer, styrene/butadiene copolymer, styrene/maleic anhydride copolymer, polyethylene resin or polypropylene resin.

The polymer agents further include polyurethane resin, epoxy resin, silicone resin, polyamide resin, modified rosin, paraffins or waxes, carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate) or polyphosphates. Especially useful are polyesters of aromatic or aliphatic dicarboxylic acids with one or more aliphatic diols, such as polyesters of isophthalic or terephthalic or fumaric acid with diols such as ethylene glycol, cyclohexane dimethanol or bisphenol adducts of ethylene or propylene oxides.

Preferably the acid values (expressed as milligrams of potassium hydroxide per gram of resin) of the polyester resins are in the range of 2-100. The polyesters can be saturated or unsaturated. Of these resins, styrene/acryl and polyester resins are particularly effective.

In the practice of this invention, it is particularly advantageous to utilize resins having a viscosity in the range of 1 to 100 centipoise when measured as a 20 weight percent solution in ethyl acetate at 25° C.

Various additives generally present in electrophotographic toner can be added to the polymer agent prior to compounding or dissolution in the solvent, or after the dissolution step itself, such as charge control agent, colorant, wax, magnetic carrier, for example iron oxide, or surface treatment agent or combination thereof.

Colorants, a pigment or dye, suitable for use in the practice of the present invention are disclosed, for example, in U.S. Reissue Pat. No. 31,072 and in U.S. Pat. Nos. 4,160,644; 4,416,965; 4,414,152 and 2,229,513. Colorants be red, green, blue, black, magenta, cyan, yellow, and any combination of these colorants and include, for example, carbon black, Aniline Blue, Calcoil Blue, Chrome Yellow, Ultramarine Blue, SunBright Blue 61, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1 or C.I. Pigment Blue 15:3. Colorants can generally be employed in the range of from 1 to 90 weight percent on a total toner powder weight basis, and preferably in the range of 2 to 20 weight percent, and most preferably from 4 to 15 weight percent in the practice of this invention. When the colorant content is 4% or more by weight, a sufficient coloring power can be obtained, and when it is 15% or less by weight, good transparency can be obtained. Mixtures of colorants can also be used. Colorants in any form such as dry powder, its aqueous or oil dispersions, wet cake, or masterbatches can be used in the present invention. Colorant milled by any methods like media-mill or ball-mill can be used as well. The colorant can be incorporated in the oil phase or in the first aqueous phase in the ELC process.

The release agents used herein are waxes. Concretely, the releasing agents usable herein are low-molecular weight polyolefins such as polyethylene, polypropylene or polybutylene; silicone resins which can be softened by heating; fatty acid amides such as oleamide, erucamide, ricinoleamide or stearamide; vegetable waxes such as carnauba wax, rice wax, candelilla wax, Japan wax or jojoba oil; animal waxes such as bees wax; mineral or petroleum waxes such as montan wax, ozocerite, ceresine, paraffin wax, microcrystalline wax or Fischer-Tropsch wax; or modified products thereof. When a wax containing a wax ester having a high polarity, such as carnauba wax or candelilla wax, is used as the releasing agent, the amount of the wax exposed to the toner particle surface is inclined to be large. On the contrary, when a wax having a low polarity such as polyethylene wax or paraffin wax is used, the amount of the wax exposed to the toner particle surface is inclined to be small. Oils can also be used as release agents. Irrespective of the amount of the wax inclined to be exposed to the toner particle surface, waxes having a melting point in the range of 30 to 150° C. are preferred and those having a melting point in the range of 40 to 140° C. are more preferred. The wax concentration is, for example, 0.1 to 20 weight % and preferably 0.5 to 8 weight %, based on the weight of the toner.

The term charge control refers to a propensity of a toner addendum to modify the triboelectric charging properties of the resulting toner. A very wide variety of charge control agents also defined as charge transfer agents, for positive charging toners are available. A large, but lesser number of charge control agents for negative charging toners, is also available. Suitable charge control agents are disclosed, for example, in U.S. Pat. Nos. 3,893,935; 4,079,014; 4,323,634; 4,394,430 and British Patents 1,501,065; and 1,420,839. Charge control agents are generally employed in small quantities such as, from 0.1 to 5 weight percent based upon the weight of the toner. Additional charge control agents that are useful are described in U.S. Pat. Nos. 4,624,907; 4,814,250; 4,840,864; 4,834,920; 4,683,188 and 4,780,553. Mixtures of charge control agents can also be used.

Toner particles of the present invention can also contain flow aids in the form of surface treatment agent. The toner powder can be surface treated with various surface treatment agent additives, such as, for example, silica and charge control agents, in order to adjust various characteristics of the toner powder, such as the flow and electrostatic properties thereof. The additives are in the form of particles of a super-fine particle size, such as, for example, a volume median particle size in the sub-micron or nanometer range. Surface treatments are typically in the form of inorganic oxides or polymeric powders with typical particle sizes of 5 nm to 1000 nm. With respect to the surface treatment agent also known as a spacing agent, the amount of the agent on the toner particles is an amount sufficient to permit the toner particles to be stripped from the carrier particles in a two component system by the electrostatic forces associated with the charged image or by mechanical forces. Preferred amounts of the spacing agent are from 0.05 to 10 weight %, and most preferably from 0.1 to 5 weight %, based on the mass of the toner.

The spacing agent can be applied onto the surfaces of the toner particles by conventional surface treatment techniques such as, but not limited to, conventional powder mixing techniques, such as tumbling the toner particles in the presence of the spacing agent. Preferably, the spacing agent is distributed on the surface of the toner particles. The spacing agent is attached onto the surface of the toner particles and can be attached by electrostatic forces or physical means or both. With mixing, preferably uniform mixing is achieved by such mixers as a high energy Henschel-type mixer which is sufficient to keep the spacing agent from agglomerating or at least reduces agglomeration.

Furthermore, when the surface treatment agent is mixed with the toner particles in order to achieve distribution on the surface of the toner particles, the mixture can be sieved to remove any agglomerated spacing agent or agglomerated toner particles. Other means to separate agglomerated particles can also be used for purposes of the present invention.

The preferred spacing agent is silica, such as those commercially available from Degussa, like R-972, or from Wacker, like H2000. Other suitable spacing agents include, but are not limited to, other inorganic oxide particles, polymer particles and the like. Specific examples include, but are not limited to, titania, alumina, zirconia, or other metal oxides; and also polymer particles preferably less than 1 μm in diameter (more preferably 0.1 μm), such as acrylic polymers, silicone-based polymers, styrenic polymers, fluoropolymers, copolymers thereof, and mixtures thereof.

In the present invention of toner particles made by conventional melt processing, the silver sulfate is added to the compounder as one of several ingredients as noted above. The silver sulfate is preferably made into a master batch, typically at a concentration of 1-10 weight %, more preferably between 4-7 weight %, and most preferably at 5-6 weight %. The silver sulfate can also be made into a final composition, the preferred concentration of 0.0005 to 10 weight % silver sulfate, more preferred 0.0007 to 5 weight % silver sulfate, most preferred 0.001 to 1 weight % silver sulfate. A method for making the composite of the silver sulfate, together with any optional addenda, in polymer agent is melt blending with the thermoplastic polymer using any suitable mixing device such as a single screw compounder, blender, paddle compounder such as a Brabender, two-roll mill, spatula, press, extruder, or molder such as an injection molder. It is preferred to use a suitable batch mixer, continuous mixer or twin-screw compounder such as a PolyLab or Leistritz, to ensure proper mixing. Twin-screw extruders are built on a building block principle. Thus, mixing of the silver sulfate antimicrobial agent, temperature, mixing rotations per minute (rpm), residence time of resin, as well as point of addition of the silver sulfate antimicrobial agent can be easily changed by changing screw design, barrel design and processing parameters. Similar machines are also provided by other compounder manufacturers like Werner and Pfleiderrer, Berstorff, and the like, which can be operated either in the co-rotating or the counter-rotating mode.

One method for making the initial composition is to melt polymer in a glass, metal or other suitable vessel, followed by addition of the other additives of the invention. The polymer and additives are mixed using a spatula until the additives are properly dispersed in the polymer, followed by the addition of silver sulfate. The silver sulfate antimicrobial is mixed using a spatula until it is appropriately dispersed in the polymer. Another method for making the composite is to melt the polymer in a small compounder, such as a Brabender compounder, followed by addition of the additives, compound until the additives are properly dispersed in the polymer, followed by addition of the silver sulfate until it is appropriately dispersed in the polymer. Yet in another method such as in the case of a single or twin-screw compounder, these compounders are provided with main feeders through which polymer pellets or powders are fed. Additives can be mixed with and fed simultaneously with the polymer pellets or powders. Additives can also be fed using a feeder located downline from the polymer feeder. Both procedures will produce an initial composition. The silver sulfate is then fed using a top feeder or using a side stuffer. If the side stuffer is used to feed the silver-based antimicrobial agent then the feeder screw design needs to be appropriately configured. The preferred mode of addition of the silver sulfate to the thermoplastic polymer is by the use of a side stuffer, although a top feeder can be used, to ensure proper viscous mixing and to ensure dispersion of the silver sulfate agent through the initial composition polymer matrix as well as to control the thermal history.

Alternatively, the initial composition containing the additives of the invention can be compounded and collected, then fed through the main feeder before addition of the silver-based antimicrobial agent. In one embodiment, the silver sulfate antimicrobial agent can be pre-dispersed along with the polymer and additives of the invention in the initial composition using a mixing apparatus such as a Henschel Mixer and compounded using the methods described. The resulting composite material obtained after compounding can be further processed into pellets, granules, strands, ribbons, fibers, powder, films, plaques, foams and the like for subsequent use.

A master batch of silver sulfate in polymer agent and any additives can be further diluted by compounding the master batch with polymer agent and additives of the invention, resulting in a silver sulfate preferred concentration of 0.0005 to 10 weight % silver sulfate, more preferred 0.0007 to 5 weight % silver sulfate, most preferred 0.001 to 1 weight % silver sulfate. The extruded composite including polymer agent, additives, and silver sulfate is then mechanically ground in a way known to anyone skilled in the art. Silver sulfate concentration in toner is analyzed using Inductively Coupled Plasma (ICP) or X-ray Fluorescence (XRF) to measure elemental silver and X-ray Diffraction (XRD) to confirm silver sulfate is present. ICP measurements were carried out using a Perkin Elmer Optima 2000 ICP optical emission spectrometer, XRF measurements were carried out using a Bruker S8 wavelength dispersive XRF spectrometer, XRD measurements were carried out using a Rigaku D2000 diffractometer.

In the ELC process, a suitable dispersion of silver sulfate is added to the organic phase. The oil phase is processed as before, with particular care taken as to how the particulate stabilizer is removed. Typically, a strong base is used to digest the silica, but this can cause a reduction of silver sulfate to silver oxide, which has no antimicrobial efficacy. Another method is to apply ultrasonic or megasonic energy to dislodge the silica from the surface of the toner particle, without destroying the particle itself.

A modified ELC process can be used to create porous toner particles. In this process, silver sulfate is added via a suitable dispersion to the first aqueous phase. The process for making the porous particles involves a three-step process. The first step involves the formation of a stable water-in-oil emulsion, including a first aqueous solution of a pore stabilizing hydrocolloid dispersed finely in a continuous phase of a binder polymer dissolved in an organic solvent. This first water phase creates the pores in the particles of this invention and the pore stabilizing compound controls the pore size and number of pores in the particle, while stabilizing the pores such that the final particle is not brittle or fractured easily. The particle has a porosity of at least 10. The second step in the formation of the porous particles of this invention involves forming a water-in-oil-in-water emulsion by dispersing the above mentioned water-in-oil emulsion in a second aqueous phase containing either stabilizer polymers such as poylvinylpyrrolidone or polyvinylalcohol or more preferably colloidal silica such as LUDOX™ or NALCO™ or latex particles in a modified ELC process described in U.S. Pat. Nos. 4,883,060; 4,965,131; 2,934,530; 3,615,972; 2,932,629 and 4,314,932. Specifically, in the second step of the process of the present invention, the water-in-oil emulsion is mixed with the second aqueous phase containing colloidal silica stabilizer to form an aqueous suspension of droplets that is subjected to shear or extensional mixing or similar flow processes, preferably through an orifice device to reduce the droplet size, yet above the particle size of the first water-in-oil emulsion, and achieve narrow size distribution droplets through the limited coalescence process. The pH of the second aqueous phase is generally between 4 and 7 when using silica as the colloidal stabilizer. The third step in the preparation of the porous particles of this invention involves removal of both the solvent that is used to dissolve the binder polymer and most of the first water phase so as to produce a suspension of uniform porous polymer particles in aqueous solution. The rate, temperature and pressure during drying will also impact the final particle size and surface morphology. Clearly the details of the importance of this process depend on the water solubility and boiling point of the organic phase relative to the temperature of drying process. Solvent removal apparatus such as a rotary evaporator or a flash evaporator can be used in the practice of the method of this invention. The polymer particles are isolated after removing the solvent by filtration or centrifugation, followed by drying in an oven at 40° C. that also removes any water remaining in the pores from the first water phase. Optionally, the particles are treated with alkali to remove the silica stabilizer. Optionally, the third step in the preparation of porous particles described above can be preceded by the addition of additional water prior to removal of the solvent, isolation and drying. The preferred porosity of porous toner particles is from 30 to70 percent.

The mixture of clear or colored toner includes toner particles. The shape of the toner particles has a bearing on the electrostatic toner transfer and cleaning properties. In the present invention, toner particles are characterized by having a specific shape. One measure of shape is to quantify the closeness to a perfect circle. For this one can use the parameter circularity which is defined as follows:

Circularity=4λA/P²

where A is the particle area and P is its perimeter. Circularity is a ratio of the perimeter of a circle with the same area as the particle divided by the perimeter of the actual particle image. Circularity has values in the range 0-1. A perfect circle has a circularity of 1 while an irregular shaped object has a circularity value closer to 0. Circularity is sensitive to both overall form and surface roughness. Toner circularity is evaluated using a Sysmex FPIA-3000 from Malvern Instruments. The reported measurement value is the Mean Circularity. For any toner material a range of shapes is produced. The preferred mean circularity range is 0.7 to 1.0, the more preferred range is 0.85 to 1.0, and the most preferred range is 0.93 to 1.0. A number of procedures to control the shape of toner particles are known in the art. In the practice of this invention, additives can be employed in the second water phase or in the oil phase if necessary. The additives can be added after or prior to forming the water-in-oil-in-water emulsion. In either case the interfacial tension is modified as the solvent is removed resulting in a reduction in sphericity of the particles. U.S. Pat. No. 5,283,151 describes the use of carnauba wax to achieve a reduction in sphericity of the particles, U.S. Pat. No. 7,662,535 describes the use of certain metal carbamates that are useful to control sphericity, U.S. Pat. No. 7,655,375 describes the use of specific salts to control sphericity. U.S. Patent Application Publication 2007298346 describes the use of quaternary ammonium tetraphenylborate salts to control sphericity.

Another method to produce an antimicrobial toner is to take a toner made by conventional, ELC or porous methods and to add the antimicrobial agent to the resulting particle by a surface treatment process described above. The antimicrobial agent is then active on the surface and in domains within the particle.

Toner particles of the present invention are used to make images on a substrate. The toner is affixed to a substrate or page using an electrophotographic printer also referred to as a copier, photocopier, or copier machine, available in commercial and noncommercial settings. The substrate can be inorganic, organic, paper, polymer, metal or a combination thereof. The image can be transparent defined as a clear toner overcoat. The minimum components in a clear toner overcoat are polymer agent and silver salt. The silver salt can be silver sulfate. The clear toner overcoat is typically added to an image and substrate to provide gloss to the image and substrate. Clear toner overcoat is printed in one of two ways, a constant amount and constant mass of clear overcoat toner over the entire image or substrate, or a varying amount or varying mass on a substrate as a function of the image content. The varying mass can be defined as having a variable image value of 0 to 100% depending on image content. A clear toner overcoat can have additional components described above.

The image can be nontransparent defined as a colored toner image. The minimum components in a colored toner image are polymer agent, colorant and a silver salt. The silver salt can be silver sulfate. A colored toner image can have additional components described above. A colored toner image can be in the form of text, as letters, numbers, symbols, or as a picture or solid image with one or more colored toners over a portion of a substrate or the entire substrate. The image can include clear toner overcoat only, colored toner image only, or a combination of clear toner overcoat and colored toner image. The amount of silver sulfate in a clear toner overcoat is measured as coverage by ICP as micrograms Ag₂SO₄ per total sample weight. The amount of silver sulfate in a colored toner image is measured as coverage by ICP as micrograms Ag₂SO₄ per total sample weight.

The following is a simple description of how a photocopier image is produced:
1) Place the item to be copied on the copier's glass surface or in a feeder to place on the glass surface.
2) The copier photoconductor belt, defined as a belt or drum, is positively or negatively charged.
3) Intense light scans the item being copied. Light is fully or partially reflected off white and bright areas, fully or partially absorbed in dark areas.
4) Light reflected onto the drum causes electrons to be released neutralizing the charge on those regions of the drum, dark areas of the item being copied do not reflect light leaving those regions of the drum charged.
5) Charged toner is spread over the drum's surface and adheres to regions of opposite charge.
6) A substrate with a charge that is opposite of the toner is passed over the surface of the drum and attracts the toner away from the drum.
7) The toner is fused or fixed to the substrate surface by applying heat and pressure to the toner coated substrate.

The silver sulfate in the present invention is present in a clear toner overcoat or a colored toner image, on a substrate providing antibacterial and antifungal protection. Antimicrobial efficacy is tested by utilizing standard biological methods referred to as challenge tests whereby an image printed on paper using toner of the present invention is exposed to a particular microbe under controlled conditions. Samples were evaluated for antimicrobial activity using modified versions of the American Society for Testing and Materials methods ASTM E-2149, “Standard Test Method for Determining the Antimicrobial Activity of Immobilized Antimicrobial Agents Under Dynamic Contact Conditions” and ASTM E-2180 “Standard Test Method for Determining the Activity of Incorporated Antimicrobial Agent (s) in Polymeric or Hydrophobic Materials”. In these tests, substrates with printed images including toner of the present invention were inoculated with challenge organisms of bacteria (Klebsiella pneumonia) or fungi (Aspergillus Brasiliensis, previously referred to as Aspergillus Niger). The time and exposure conditions (temperature, relative humidity, for example) are controlled to promote growth of the organism and controls are run in parallel to establish colony viability and to establish blank substrates are compatible with the organisms (i.e. that they don't have antimicrobial effects without the test agent). In some procedures nutrients are added to further promote growth. Qualitative methods involve visual observations of zones of inhibition (no presence of organisms in direct contact with or in the vicinity of the sample). Quantitative methods measure reduction in colonies over the course of the test period. A reduction of greater than 50% demonstrates efficacy against the challenge organism.

Clear toner overcoat images are assessed for gloss.

Gloss correlates to the surface appearance of a substrate. Qualitatively, it indicates how shiny or lustrous, metallic or matte a surface appears. As more direct light is reflected, the impression of gloss increases. To ensure an accurate and repeatable measurement, gloss is measured by a glossmeter. Printed materials and paper have a gloss range from the low single digits for uncoated bond paper for example laser paper, up to 35 for coated glossy media, and in the 50-70 range for cast-coated media. A single angle unit using a 60 degree incident light angle covers this range best.

Clear toner particles and colored toner particles are assessed for consistent level of charge.

Preferably, the charge control agent is capable of providing a consistent level of charge for clear toner particles and colored toner particles. For purposes of the present invention, a consistent level of charge is expressed as charge Q in microcoulombs, μC, per mass m in grams, g, where Q/m is μC/g. The preferred range for Q/m is from −20 to −100 μC/g for a toner particle size of 4 to 25 microns. A more preferred range of Q/m is −25 to −60 μC/g for a toner particle size of 5 to 10 microns. The toner Q/m ratio can be measured in a MECCA device having two spaced-apart, parallel, electrode plates which can apply both an electrical and magnetic field to the developer samples, thereby causing a separation of the two components of the mixture, i.e., carrier and toner particles, under the combined influence of a magnetic and electric field. A 0.100 g sample of a developer mixture is placed on the bottom metal plate. The sample is then subjected for thirty (30) seconds to a 60 Hz magnetic field and potential of 2000 V across the plates, which causes developer agitation. The toner particles are released from the carrier particles under the combined influence of the magnetic and electric fields and are attracted to and thereby deposit on the upper electrode plate, while the magnetic carrier particles are held on the lower plate. An electrometer measures the accumulated charge of the toner on the upper plate. The toner Q/m ratio is calculated by dividing the accumulated charge by the mass of the deposited toner taken from the upper plate. In order to correctly predict the effect of toner formulation on charge with developer life, a developer at 20 percent toner concentration is first prepared. The developer is then permitted to exercise in the presence of a development roller in which the core is rotating at 2000 rpm. After 1 hour of exercise, the developer is removed and the toner is separated from the carrier by exposing the developer to high voltage of opposite polarity to toner. The stripped carrier is then rebuilt with fresh toner at 10 percent toner concentration. The developer is first wrist shaken for 2 minutes and Fresh charge is measured using the MECCA device. This developer is then placed on a magnetic roller where it is exercised for 10 minutes with a magnetic core rotating at 200 rpm. The Aged charged is measured again using MECCA.

Color toner images or color toner images with a clear overcoat are assessed for colorimetric and background.

The CIE (Commission Internationale De L'Eclairage or International Commission on Illumination) has created a colorimetric measurement transform, called L* a* b*, or otherwise referred to as CIE Lab. L=lightness (0=total dark black, 100=brightest white) and a and b define color hue +b=yellow, −b=blue, +a=red, −a=green. All colors fall within this grid, and by mapping out all possible colors that a printing device can produce, you define the printer gamut. For comparison samples, a new toner (clear or colored toner) should remain neutral over the useful tone scale range.

Background is a measurement of unwanted ink or toner particles deposited in what should be white areas of a document. Pigments or additives can influence the charging behavior of toner, which can in turn cause background. Various methods are used which count particles in white image regions, including Colorimetry. Measurements of “white” areas of a printed page are measured on multiple sheets printed with a 3-color process vs. the same 3-color process plus a new component (for instance, black or clear toner with an antimicrobial additive). In this way the background effect of the 3- other colors is common to both sets of measurements and the difference can be assigned to the new component, say for instance the black toner with an antimicrobial agent. The a*and b* measurements are indicative of the variability of the other 3-colors, whereas the L is a combination of all colors but weighted more heavily by black. The dE metric (root mean square error of the L, a, and b values for the two samples) and dL metric (simple difference between L values) should be below the visual threshold of 1.0 for paired comparison samples.

### EXAMPLES

Examples of the present invention were evaluated based on ability to be successfully formulated, color, printability using an electrophotographic copier, and efficacy or any combination of these four criteria.

Silver sulfate antimicrobial, polyester polymer, charge control agent, carbon black, pigment, and surface treatment agent or any combination thereof was used in the examples of this invention.

### Example 1 Inventive

All samples of Example 1 were generated in ambient air. Mixing was performed using a stainless steel spatula. Heating was performed using a Magna-4 hot plate.

Into a glass beaker was charged a designated amount of polyester polymer. The polyester polymer was heated using the Magne-4 Hot Plate at setting 5 until the polyester polymer was visibly melted.

In samples 1-7 was charged a designated amount of Ag₂SO₄ into the beakers containing the melted polyester polymer. This melt mixture was stirred for 1 minute. An aliquot of the molten composite was removed from the beaker and spread onto a Teflon sheet, then permitted to cool to ambient temperature (22° C.). The resulting solid plaque was removed from the Teflon sheet, identified with a sample number, and evaluated visually for color.

In samples 8-11 was charged a designated amount of charge control agent into the beakers containing the melted polyester polymer. The melt mixture was mixed until the charge control agent was well dispersed. A designated amount of Ag₂SO₄ was then charged into the beakers containing the melted polyester polymer/charge control agent composite. This melt mixture was stirred for 1 minute. An aliquot of the molten composite was removed from the beaker and spread onto a Teflon sheet, then permitted to cool to ambient temperature (22° C.). The solid plaque was removed from the Teflon sheet, identified with a sample number, and evaluated visually for color. In sample 12 was charged a designated amount of charge control agent into the beaker containing the melted polyester polymer. The melt mixture was mixed until the charge control agent was well dispersed. A designated amount of Sample 11 of this experiment was then charged into the beaker containing the melted polyester polymer/ charge control agent composite. This melt mixture was stirred for 1 minute. An aliquot of the molten composite was removed from the beaker and spread onto a Teflon sheet, then permitted to cool to ambient temperature (22° C.). The solid plaque was removed from the Teflon sheet, identified with a sample number, and evaluated visually for color.

| | Polyester | Charge control | | weight % |
|---|---|---|---|---|
| Sample ID | polymer (g) | agent (g) | Ag₂SO₄ (g) | Ag₂SO₄ |
| 1 | 20.030 | 0 | 0 | 0 |
| 2 | 19.008 | 0 | 1.004 | 5.01 |
| 3 | 19.823 | 0 | 0.207 | 1.03 |
| 4 | 19.067 | 0 | 0.999 | 4.97 |
| 5 | 19.826 | 0 | 0.200 | 0.99 |
| 6 | 19.008 | 0 | 0.999 | 4.99 |
| 7 | 19.776 | 0 | 0.201 | 1.01 |
| 8 | 17.956 | 2.003 | 0 | 0 |
| 9 | 18.042 | 0.406 | 1.013 | 5.20 |
| 10 | 19.015 | 0.404 | 1.067 | 5.20 |
| 11 | 19.400 | 0.403 | 0.208 | 1.04 |
| 12 | 18.978 | 0.399 | 0.995 | 0.0508 |

Composite 1-12 of Example 1 were successfully formulated. Ag₂SO₄ can be compounded with polyester polymer and charge control agent composites. Visual evaluation of final toner color found all to be acceptable.

### Example 2 Inventive

All samples were generated in ambient air. Mixing was performed using a Werner Pfleiderer ZSK30NM9 twin screw compounder.

Into a steel vessel was charged a 9.5 kg polyester polymer and 500 g Ag₂SO₄. This powder mixture was poured into a Henschel mixer and mixed 1 min. The mixed powder was collected and fed into the compounder at a rate of 15 kilograms per hour. The resulting extruded polymer sheet was collected as large flat pieces. The flat pieces were ground using a Cumberland 0 GRAN 3KN granulator resulting in a coarse ground powder. The resulting coarse ground powder is clear overcoat toner masterbatch. Using ICP, the Ag₂SO₄ concentration was measured to be 4.6 weight %. Example 2 with 4.6 weight % Ag₂SO₄ did not have a noticeable effect on color.

Using a MECCA device, the clear overcoat toner masterbatch of Example 2 was evaluated for consistent level of charge.

| Sample ID | Fresh Charge (μC/g) | Aged Charge (μC/g) |
|---|---|---|
| Example 2 | −33 | −41 |

All consistent level charge metrics for clear overcoat toner masterbatch of Example 2 confirm that the Ag₂SO₄ had no adverse effect on toner particle charging.

### Example 3—Inventive

All samples were generated in ambient air. Mixing and compounding were performed using a two-roll mill.

Into the two-roll mill was charged and mixed for 15 minutes designated amounts of preblended polyester polymer, charge control agent, and Ag₂SO₄. The resulting clear toner material was then cooled to room temperature, coarse ground using a Wiley™ mill with a 2 mm screen. The coarse ground powder was then jet milled using a TrostTX fluid energy mill. The resulting clear overcoat toner powder median diameter particle size was 8-10 microns by volume percent, as measured by Coulter Counter.

Using a MECCA device, the clear overcoat toner powders of Example 3 were evaluated for consistent level of charge.

| | Polyester | Charge | | | Fresh | Aged |
|---|---|---|---|---|---|---|
| Sample | polymer | control | Ag₂SO₄ | weight % | Charge | Charge |
| ID | (g) | agent (g) | (g) | Ag₂SO₄ | (μC/g) | (μC/g) |
| A | 25 | 0.5 | 0.25 | 0.97 | −30 | −54 |
| B | 25 | 0.5 | 0.5 | 1.92 | −30 | −57 |
| C | 25 | 0.5 | 1 | 3.77 | −29 | −58 |
| D | 25 | 0.5 | 2 | 7.27 | −30 | −56 |

All consistent level charge metrics for clear overcoat toner powders of Example 3 confirm that the Ag₂SO₄ had no adverse effect on toner particle charging.

### Example 4 Inventive

All samples were generated in ambient air. Mixing was performed using a Werner Pfleiderer ZSK3ONM9 twin screw compounder.

Into a steel vessel was charged a 9.7 kg polyester polymer, 200 g of charge control agent, and 100 g of the masterbatch made in Example 2. This powder mixture was poured into a Henschel mixer and mixed 2 min. The mixed powder was collected and fed into the compounder at a rate of 15 kilograms per hour. The resulting extruded polymer sheet was collected as large flat pieces.

The flat pieces were ground using a Cumberland 0 Gran 31(N granulator. The coarse ground powder was further ground using a Hosokawa 100 AFG pulverizer at a feed rate of 4.5 kg/h to produce a fine ground powder. The resulting fine ground powder was further processed using a Hosokawa ATP-50 Classifier resulting in a mean particle size distribution of 7.923 microns by volume percent, as measured by Coulter Counter. The resulting final ground powder is clear overcoat toner dilution sample. Using ICP, the Ag₂SO₄ concentration was measured to be 0.17 weight %. Example 4 with 0.17 weight % Ag₂SO₄ did not have a noticeable effect on color.

The clear toner overcoat dilution sample of Example 4 was placed in a Henschel mixer, to which was added 1 weight % of fumed silica surface treatment agent and mixed for 10 min. The resulting mixture is a clear toner overcoat dilution sample with surface treatment. This surface treated sample of Example 4 can be used in an electrophotographic copier to produce a copier overcoat toner image.

### Example 5 Inventive

Copier overcoat toner images were produced using Example 4 surface treated clear toner overcoat dilution sample using a NexPress 2100 digital printing press. Overcoat toner image values were 0, 40, 70, and 100% where 0% had 0 mg/cm² overcoat toner and 100% had 0.526 mg/cm² overcoat toner.

An overcoat toner image was deposited on solid color images and on a substrate with no solid color image. Analysis by ICP for an aliquot from an overcoat toner image deposited on a solid color image and an overcoat toner image deposited on Lustro Gloss 216gm determined the Ag₂SO₄ coverage was:

| | ICP Ag₂SO₄ |
|---|---|
| Sample | micrograms/gram |
| overcoat toner image deposited on a solid | 25 |
| color image | |
| overcoat toner image deposited on a | 23 |
| substrate | |

Samples from Example 4 with clear toner overcoat were tested for antimicrobial efficacy using ASTM E-2149.

Bacteria: Klebsiella pneumonia

### Protocol: ASTM-E2149

### Results @1 Hour:

| | Average | Average |
|---|---|---|
| Sample Name | CFU/ml | % Reduction |
| 0% clear toner overcoat No. 1 | 1.5e5 | −11.1 |
| 0% clear toner overcoat No. 2 | | |
| 100% clear toner overcoat No. 1 | 1.2e3 | 99.1 |
| 100% clear toner overcoat No. 2 | | |

Results at 1 hour show clear toner overcoat with Ag₂SO₄ demonstrates antimicrobial efficacy against bacteria.

### Fungus: Aspergillus Brasiliensis

### Protocol: ASTM-E2149

Results @2 Days:

| | Average | Average |
|---|---|---|
| Sample Name | CFU/ml | % Reduction |
| 0% clear toner overcoat No. 1 | 1.0E+5 | 29.3 |
| 0% clear toner overcoat No. 2 | | |
| 100% clear toner overcoat No. 1 | <10 | 100 |
| 100% clear toner overcoat No. 2 | | |

Results at 2 days show clear toner overcoat with Ag₂SO₄ demonstrates antimicrobial efficacy against fungi.

### Example 6 Inventive

All samples were generated in ambient air. Mixing was performed using a Werner Pfleiderer ZSK30NM9 twin screw compounder.

Into a steel vessel was charged 10 kg polyester polymer, 443 g of Example 2, 315 g carbon black, 210 g charge control agent, and 104 g pigment. This powder mixture was poured into a Henschel mixer and mixed 2 min. The mixed powder was collected and fed into the compounder at a rate of 15 kilograms per hour. The resulting extruded polymer sheet was collected as large flat pieces. The flat pieces were ground using a Cumberland 0 GRAN 3KN granulator resulting in a coarse ground powder. The resulting coarse ground powder is colored toner diluted sample. The coarse ground powder was further ground using a Hosokawa 100 AFG pulverizer at a feed rate of 3.5 kg/h to produce a fine ground powder. The resulting fine ground powder was further processed using a Hosokawa ATP-50 Classifier resulting in a mean particle size distribution of 8.00 microns by volume percent, as measured by Coulter Counter. The resulting final ground powder is colored toner dilution sample. Using ICP, the Ag₂SO₄ concentration was measured to be 0.17 weight %. Example 6 with 0.17 weight % Ag₂SO₄ did not have a noticeable effect on color.

The colored toner dilution sample of Example 6 was placed in a Henschel mixer, to which was added 1.2 weight % of fumed silica surface treatment agent and mixed for 10 min. The resulting mixture is colored toner dilution sample with surface treatment. This surface treated sample of Example 6 can be used in an electrophotographic copier to produce a copier colored toner image.

### Example 7 Inventive

Copier toner images were produced using Example 6 surface treated black toner sample using a NexPress 2100 digital printing press. Toner image values were 0, 40, and 100% where 0% had 0 mg/cm² black toner and 100% had 0.288 mg/cm² black toner.

An overcoat toner image was deposited on black solid color images and on a substrate with no solid color image. Overcoat toner image values were 0 and 100% where 0% had 0 mg/cm² overcoat toner and 100% had 0.526 mg/cm² overcoat toner. The substrates tested were Hanno Art 350 gsm Coated Glossy Media, Sterling Ultra Digital Gloss 118 gsm Media and Teslin polyolefin media. Analysis by ICP determined the Ag₂SO₄ coverage was:

| | ICP Ag₂SO₄ |
|---|---|
| Sample | micrograms/gram |
| Black colored toner image | 10 |
| Clear overcoat toner image deposited on | 9 |
| black colored toner image | |

Printed samples were also analyzed for image quality and bio-efficacy as follows:

### Image Quality:

Gloss: Gloss was measured as follows:

### Antimicrobial Black Toner Printed Page G60 Gloss

BYK Gardner micro-TM-gloss; G60 gloss
Hanno Art, 350 gsm Coated Glossy Media

| | | G60 | Comments |
|---|---|---|---|
| | paper | 29.70 | paper gloss |
| | only | | |
| amount of | low | 19.25 | It is typical that mid-laydown of ink |
| Antimicrobial | medium | 12.53 | causes lower gloss, and when laydown |
| black toner | high | 34.48 | becomes continuous layer gloss is |
| | | | higher. Goal is to match paper gloss |
| | | | on average (including multiple color |
| | | | layers), which the antimicrobial |
| | | | black toner satisfies. |

Colorimetry: The sample was compared with a paper only sample using a Gretag model SPM100 (D50/2 observer CIE Lab Measurements). The substrate used was Hanno Art, 350 gsm, coated Glossy Media.

| | | L* | a* | b* | Comments |
|---|---|---|---|---|---|
| | paper | 94.33 | −0.18 | −2.62 | typical paper is slightly |
| | only | | | | blue |
| amount of | low | 81.72 | −0.34 | −1.97 | The antimicrobial black |
| Black toner | medium | 59.43 | −0.27 | −0.25 | toner remains neutral |
| with | high | 25.22 | −0.10 | 1.44 | over the useful tone |
| Antimicrobial | | | | | scale range |
| toner | | | | | |

Background: Samples from the same substrate were tested on the same colorimeter to determine background level differences with this black antimicrobial toner.

Background as Measured by Color Shift

| | |
|---|---|
| Sheet with no | sheet with |
| black image | black image |

| sample | L* | a* | b* | L* | a* | b* |
|---|---|---|---|---|---|---|
| 1 | 94.40 | −0.06 | −2.63 | 94.53 | −0.07 | −2.80 |
| 2 | 94.41 | −0.05 | −2.28 | 94.32 | −0.16 | −2.68 |
| 3 | 94.59 | −0.02 | −2.56 | 94.50 | −0.16 | −2.29 |
| 4 | 94.39 | −0.09 | −2.21 | 94.40 | −0.08 | −2.64 |
| 5 | 94.32 | −0.03 | −2.48 | 94.33 | −0.13 | −2.42 |
| 6 | 94.45 | −0.10 | −2.35 | 94.29 | −0.18 | −2.74 |
| average | 94.43 | −0.06 | −2.42 | 94.40 | −0.13 | −2.60 |

dE 0.19
dL* 0.03
dE and dL* metrics are well below the visual threshold of 1.0 for paired comparisons.

All image metrics confirm that the antimicrobial toner had no adverse effect on printed image quality.

### Bio-Efficacy:

Toner from Example 6 was printed on a polyolefin film substrate (Teslin) with a Nexpress 2100 printer and was tested for antimicrobial efficacy using ASTM 2180. Toner image values were 40 and 100% where 100% had 0.288 mg/cm² overcoat toner.

### Klebsiella Pneumonia:

| | | | | | Percent |
|---|---|---|---|---|---|
| | | | | | Reduction |
| | Raw Data | | | Average | from Teslin |
| Sample ID | in CFU | | | CFU/ml | Control |
| Black Toner (0.16%), No | 234 | 274 | 254 | 1.0 × 10⁶ | 56.5% |
| overcoat, 40% Teslin | | | | | |
| Black Toner (0.16%), No | 0 | 0 | 0 | <40 | 99.9% |
| overcoat, 100% Teslin | | | | | |
| Black Toner (0.16%), No | 189 | 183 | 187 | 7.4 × 10⁵ | 67.8% |
| overcoat, Large Font, | | | | | |
| Teslin | | | | | |

### Aspergillus Brasiliensis:

| | | | | | Percent |
|---|---|---|---|---|---|
| | | | | | Reduction |
| | Raw Data | | | Average | from Teslin |
| Sample ID | in CFU | | | CFU/ml | Control |
| Black Toner (0.16%), No | 6/5 | 2/5 | 2/4 | 1.6 × 10⁵ | 70.2% |
| overcoat, 40% Teslin | | | | | |
| Black Toner (0.16%), No | 2/4 | 1/4 | 3/4 | 1.2 × 10⁵ | 77.2% |
| overcoat, 100% Teslin | | | | | |
| Black Toner (0.16%), No | 5/3 | 0/0 | 1/2 | 7.2 × 10⁴ | 87.4% |
| overcoat, Large Font, | | | | | |
| Teslin | | | | | |

The results indicate antimicrobial efficacy against both challenge organisms.

### Example 8 Inventive

Copier overcoat toner images were produced using Example 4 surface treated clear toner overcoat dilution sample using a NexPress 2100 digital printing press. Overcoat toner image values were 0, 40, and 100% where 0% had 0 mg/cm² overcoat toner and 100% had 0.526 mg/cm² overcoat toner.

An overcoat toner image was deposited on solid color images and on a substrate with no solid color image. The substrates tested were Hanno Art 350 gsm Coated Glossy Media, Sterling Ultra Digital Gloss 118 gsm Media and Teslin polyolefin media. Analysis by ICP determined the Ag₂SO₄ coverage was:

| | ICP Ag₂SO₄ |
|---|---|
| Sample | micrograms/gram |
| 0% clear overcoat toner image on cyan image | <2 |
| 40% clear overcoat toner image on cyan image | 16 |
| 100% clear overcoat toner image on cyan image | 14 |

Printed samples were also analyzed for image quality and bio-efficacy as follows.

### Image Quality:

### Gloss:

| | Antimicrobial Clear Toner Printed Page G60 Gloss | | |
|---|---|---|---|
| | BYK Gardner micro-TRI-gloss; G60 gloss | | |
| | Hanno Art, 350 gsm Coated Glossy Media | | |
| | | G60 | Comments |
| | paper | 29.65 | paper gloss |
| | only | | |
| amount of | low | 15.95 | clear toners are designed to achieve a |
| Antimicrobial | medium | 15.05 | higher than paper gloss in solid density |
| ink | high | 41.63 | regions. The Antimicrobial toner also |
| | | | satisfies this need. |

### Colorimetry:

| | Antimicrobial Clear Toner Printed Page | | | | |
|---|---|---|---|---|---|
| | Colorimetry D50/2 degree observer CIE | | | | |
| | Lab Measurements, Gretag SPM100 | | | | |
| | Sterling Ultra Digital Gloss, 118 gsm | | | | |
| | | L* | a* | b* | Comments |
| | paper | 93.52 | 0.52 | −1.32 | typical paper is slightly |
| | only | | | | blue |
| amount of | low | 92.45 | 0.60 | −1.38 | The antimicrobial black |
| Antimicrobial | medium | 92.45 | 0.62 | −1.07 | toner remains neutral |
| clear toner | high | 92.65 | 0.80 | −0.86 | over the useful tone |
| | | | | | scale range |

All metrics confirm that the antimicrobial clear overcoat toner had no adverse effect on printed image quality.

### Bio-Efficacy:

Toner from Example 4 was printed on a polyolefin film substrate (Teslin) with a Nexpress 2100 printer and was tested for antimicrobial efficacy using ASTM 2180.

### Klebsiella Pneumonia:

| | | | | | Percent |
|---|---|---|---|---|---|
| | | | | | Reduction |
| | | | | Average | from Teslin |
| Sample ID | Raw Data in CFU | | | CFU/ml | Control |
| Teslin Control | 562 | 639 | 561 | 2.3 × 10⁶ | N/A |
| Clear Ground Toner | 0 | 8 | 0 | 320 | 99.9% |
| (0.16%), coating 40%, | | | | | |
| Teslin | | | | | |
| Clear Ground Toner | 0 | 0 | N/A | <40 | 99.9% |
| (0.16%), coating 100%, | | | | | |
| Teslin | | | | | |

### Aspergillus Brasiliensis:

| | | | | | Percent |
|---|---|---|---|---|---|
| | | | | | Reduction |
| | | | | Average | from Teslin |
| Sample ID | Raw Data in CFU | | | CFU/ml | Control |
| Teslin Control | 10 | 18 | 15 | 5.7 × 10⁵ | N/A |
| Clear Ground Toner | 3/2 | 2/9 | 1/6 | 1.5 × 10⁵ | 70.2% |
| (0.16%), coating 40%, | | | | | |
| Teslin | | | | | |
| Clear Ground Toner | 6/6 | 5/4 | 5/5 | 2.0 × 10⁵ | 63.2% |
| (0.16%), coating 100%, | | | | | |
| Teslin | | | | | |

The results indicate antimicrobial efficacy against both challenge organisms.

The invention has been described in detail with particular reference to certain preferred embodiments thereof, but it will be understood that variations and modifications can be effected within the spirit and scope of the invention.

1. A method of forming a clear toner overcoat or a colored toner image on a substrate, which provides antibacterial and antifungal protection, comprising:
providing a source of clear toner and colored toner having a mixture of polymer agent and a silver salt biocide including a silver sulfate biocide having a concentration range of 0.0005 to 10 weight %, wherein the colored toner mixture further includes a colorant;
applying the clear toner or the colored toner in image wise fashion to a substrate; and
fixing the clear or colored toner to the substrate whereby an effective coating or image is formed that provides antibacterial and antifungal protection.

2. The method of claim 1 wherein the silver sulfate biocide concentration range is 0.0007 to 5 weight %.

3. The method of claim 1 wherein the silver sulfate biocide concentration range is 0.001 to 1 weight %.

4. The method of claim 1 wherein the silver sulfate biocide particle size is in a range of greater than zero but less than 20 microns.

5. The method of claim 4 wherein the silver sulfate particle size is in a range of greater than zero but less than 10 microns.

6. The method of claim 5 wherein the silver sulfate particle size is in a range of greater than zero but less than 5 microns.

7. The method of claim 1 wherein the toner particle size in microns by volume percent has a range of 0.5-100 microns by volume.

8. The method of claim 7 wherein the toner particle size in microns by volume percent has a range of 1-75 microns by volume.

9. The method of claim 8 wherein the toner particle size in microns by volume percent has a range of 2-50 microns by volume.

10. The method of claim 1 wherein the toner mixture further includes a charge control agent.

11. The method of claim 1 wherein the toner mixture includes wax.

12. The method of claim 1 wherein the toner mixture includes colorant.

13. The method of claim 1 wherein the toner mixture includes surface treatment agent.

14. The method of claim 1 wherein the toner mixture includes a magnetic carrier.

15. The method of claim 1 wherein the toner mixture further includes a charge transfer agent, colorant, wax, magnetic carrier or surface treatment agent, or combination thereof.

16. The method of claim 12 wherein the colorant includes carbon black, Aniline Blue, Calcoil Blue, Chrome Yellow, Ultramarine Blue, SunBright Blue 61, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1 or C.I. Pigment Blue 15:3.

17. The method of claim 1 wherein the polymer agent includes homopolymers and copolymers.

18. The method of claim 17 wherein the homopolymers and copolymers includes: polyesters, styrenes, monoolefins, vinyl esters, α-methylene aliphatic monocarboxcylic acid esters, vinyl ethers, or vinyl ketones.

19. The method of claim 1 wherein the polymer agent further includes: polyurethane resin, epoxy resin, silicone resin, polyamide resin, modified rosin, paraffins or waxes, carboxymethyl cellulose (CMC), gelatin, alkali-treated gelatin, acid treated gelatin, gelatin derivatives, proteins, protein derivatives, synthetic polymeric binders, water soluble microgels, polystyrene sulphonate, poly(2-acrylamido-2-methylpropanesulfonate), polyphosphates, polyesters of aromatic or aliphatic dicarboxcylic acids with one or more aliphatic diols.

20. The method of claim 13 wherein the surface treatment agent includes: silica, titania, alumina, zirconia, or other metal oxides.

21. The method of claim 13 wherein the surface treatment agent includes polymer particles.

22. The method of claim 1 wherein the clear toner or colored toner is in the form of particles having a circularity in a range of 0.7 to 1.0 wherein circularity is defined by Circularity=4πA/P² wherein A is the particle area and P is its perimeter.

23. The method of claim 22 wherein the clear toner or colored toner is in the form of particles having a circularity range of 0.85 to 1.0.

24. The method of claim 22 wherein the clear toner or colored toner is in the form of particles having a circularity range of 0.93 to 1.0.

25. The method of claim 10 wherein the charge control agent provides a consistent level of charge Q/m to the toner particles in a range of −20 to −100 μC/g for a toner particle size of 4 to 25 microns.

26. The method of claim 10 wherein the charge control agent provides a consistent level of charge Q/m to the toner particles in a range of −25 to −60 μC/g for a toner particle size of 5 to 10 microns.

27. The method of claim 1 wherein the silver salt biocide further includes silver nitrate, silver chloride, silver bromide, silver iodide, silver iodate, silver bromate, silver tungstate, or silver phosphate.

28. An article comprising:
a substrate containing a surface;
an imagewise distribution of colorants on or near the surface; and
a clear overcoat on the surface containing a polymer and a silver salt in a range of 0.0005 to 10 weight %.

29. An article comprising:
a substrate containing a surface; and
an imagewise distribution of a polymer, a colorant and a silver salt biocide in a range of 0.0005 to 10 weight % on the surface.
